(19) United States
(12) Patent Application Publication
(10) Pub. No.: US 2016/0063186 A1
(43) Pub. Date: Mar. 3, 2016

(54) DISPLAY METHOD, COMPUTER READABLE RECORDING MEDIUM, AND DISPLAY CONTROL DEVICE

(71) Applicant: FUJITSU LIMITED, Kawasaki-shi (JP)

(72) Inventors: Shiho Miyatake, Kawasaki (JP); Takeshi Osoekawa, Ohta (JP); Junya Fujimoto, Atsugi (JP)

(21) Appl. No.: 14/825,274

(22) Filed: Aug. 13, 2015

(30) Foreign Application Priority Data
Sep. 2, 2014 (JP) 2014-178537

(51) Int. Cl. G06F 19/00

(52) U.S. Cl. CPC G06F 19/322; G06F 19/328; G06F 19/3487; G06F 19/363

(57) ABSTRACT

A server device displays a graph indicating time-series variation in load calculated according to a category of an event acquired from schedule information in which events of at least one user have been registered, and displays information indicating a payment object or a body region or symptom related to the payment object extracted from registered payment data of the one user in a manner temporally associated with the graph.

### CROSS-REFERENCE TO RELATED APPLICATION

This application is based upon and claims the benefit of priority of the prior Japanese Patent Application No. 2014-178537, filed on Sep. 2, 2014, the entire contents of which are incorporated herein by reference.

### FIELD

The embodiments discussed herein are related to a display method, a computer readable recording medium, and a display control device.

### BACKGROUND

Information and communication technologies for staying in good physical shape or maintaining good health, i.e., for so-called healthcare include, for example, a user interface system and a schedule management system.

For example, the user interface system monitors user's condition and work through information input from an operation input unit and a biological-information acquiring unit and detects user's fatigue, and determines measures of support for reducing the fatigue, and then implements the measures of support for reducing the user's fatigue by controlling an output unit and a user-interface control unit. Herewith, the user interface system aims at reducing user's fatigue by an individual means according to user's work environment, working state, physical state, and psychological state, and contents of user's work.

On the other hand, the schedule management system compares employee's physical condition data detected by his/her cell-phone with a threshold, and creates revised schedule data based on a result of the comparison. After that, the schedule management system creates content-of-change data indicating a change in employee's schedule, and sends the created content-of-change data to corresponding employee's cell-phone. Herewith, the schedule management system aims at improving productivity while reducing the level of long-term fatigue of employees etc.

Patent Document 1: Japanese Laid-open Patent Publication No. 2001-184139

Patent Document 2: Japanese Laid-open Patent Publication No. 2005-56062

However, as will be described later, the above-mentioned technologies are not always able to support healthcare effectively.

That is, the user interface system and the schedule management system both implement measures according to a physical or mental load on a user. However, the effect of a load on one's physical condition differs from one person to another. For example, when people are subjected to the same level of load, some people have an effect on their physical condition, and others don't. Even if the same measures are uniformly implemented on each one of the former and the latter, the measures exert only a limited effect. In this manner, appropriate treatment varies from one user to another; therefore, the user interface system and the schedule management system are not always able to support healthcare effectively.

### SUMMARY

According to an aspect of an embodiment, a display method includes first displaying, by a processor, a graph indicating time-series variation in load calculated according to a category of an event acquired from schedule information in which events of at least one user have been registered and second displaying, by the processor, information indicating a payment object or a body region or symptom related to the payment object extracted from registered payment data of the one user in a manner temporally associated with the graph.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a healthcare support system according to a first embodiment;

FIG. 2 is a block diagram illustrating a functional configuration of a server device according to the first embodiment;

FIG. 3 is a diagram illustrating an example of schedule data;

FIG. 4 is a diagram illustrating an example of payment data;

FIG. 5 is a diagram illustrating an example of an adding-up result;

FIG. 6 is a diagram illustrating an example of a graph;

FIG. 7 is a flowchart illustrating a procedure of a display process according to the first embodiment;

FIG. 8 is a diagram illustrating an example of learning data used in multiple regression analysis;

FIG. 9 is a diagram illustrating an example of an analysis result;

FIG. 10 is a diagram illustrating an example of notification of an analysis result; and

FIG. 11 is a diagram for explaining an example of a computer that executes a display program according to the first and second embodiments.

### DESCRIPTION OF EMBODIMENTS

Preferred embodiments will be explained with reference to accompanying drawings. Incidentally, these embodiments do not limit the technologies discussed herein. Furthermore, these embodiments can be appropriately combined within a range causing no contradiction in processing contents.

### [a] First Embodiment

### System Configuration

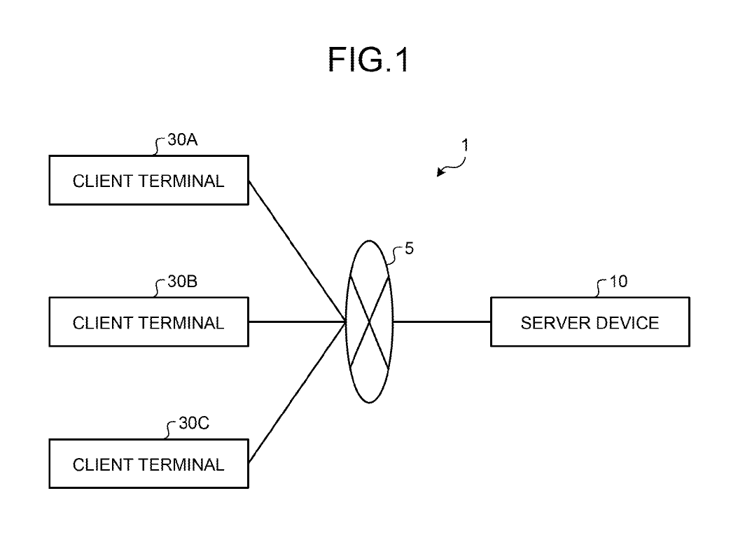

FIG. 1 is a diagram illustrating a configuration example of a healthcare support system according to a first embodiment. A healthcare support system 1 illustrated in FIG. 1 offers a healthcare support service that a server device 10 displays a correlation between time-series variation in a physical or mental load on a user of a client terminal 30 and change in user's physical condition on the client terminal 30. Herewith, the healthcare support system 1 provides healthcare information according to individual users' characteristics, thereby supporting users' healthcare effectively.

As illustrated in FIG. 1, the healthcare support system 1 contains the server device 10 and client terminals 30A to 30C. Incidentally, FIG. 1 depicts an example where three client terminals are contained; however, the number of client terminals contained in the server device 10 is not limited to the example illustrated in FIG. 1, and any number of client terminals can be contained. Incidentally, hereinafter, the client terminals 30A to 30C may collectively be referred to as the “client terminals 30” unless otherwise individually specified.

The server device 10 and the client terminals 30 are connected via a network 5 so that the server device 10 and each client terminal 30 can communicate. As the network 5, regardless of whether wired or wireless, any kinds of communication networks, including, for example, the Internet, a local area network (LAN), and a virtual private network (VPN), can be employed.

The server device 10 is a computer that provides the above-mentioned healthcare support service to the client terminals 30.

As an embodiment, the server device 10 can be implemented by installing a display program for realizing the healthcare support service as package software or online software on an intended computer. For example, the server device 10 can be implemented as a Web server that provides the healthcare support service, or can be implemented as a cloud that provides the healthcare support service by outsourcing.

The client terminals 30 are computers that receive provision of the healthcare support service from the server device 10.

As an embodiment, personal computers can be employed as the client terminals 30. Not only stationary terminals, such as personal computers, but also various portable terminal devices can be employed as the client terminals 30. The portable terminal devices include, for example, mobile communication terminals, such as a smartphone, a cell-phone, and a personal handyphone system (PHS), and slate terminals, such as a personal digital assistant (PDA).

Configuration of Server Device 10

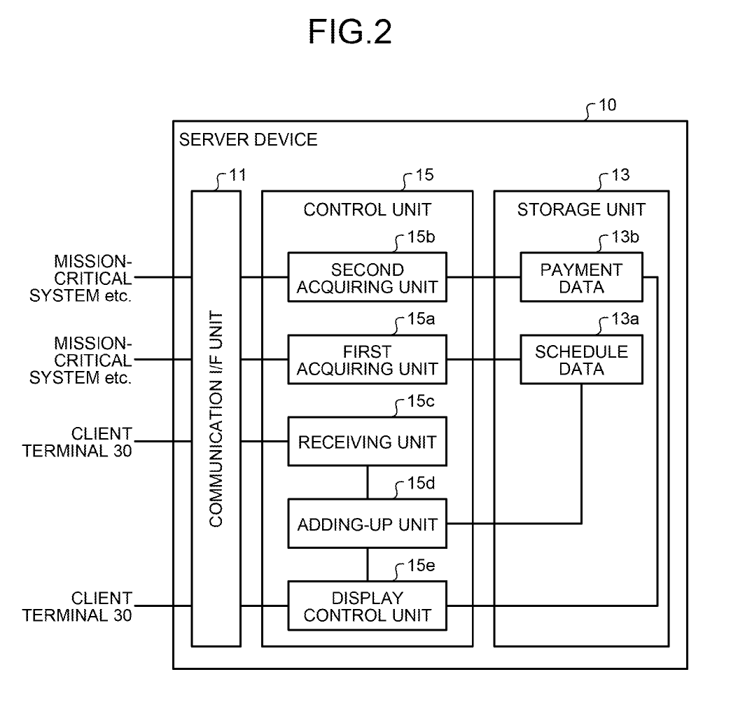

FIG. 2 is a block diagram illustrating a functional configuration of the server device 10 according to the first embodiment. As illustrated in FIG. 2, the server device 10 includes a communication interface (I/F) unit 11, a storage unit 13, and a control unit 15. Incidentally, in addition to the function units illustrated in FIG. 2, the server device 10 can include various function units that a known computer has, such as various input devices and audio output devices.

The communication I/F unit 11 is an interface that controls communication with another device, such as a client terminal 30.

As an embodiment, a network interface card, such as a LAN card, can be employed as the communication I/F unit 11. For example, the communication I/F unit 11 receives a request to display a graph indicating a correlation between time-series load variation and change in physical condition from a client terminal 30, and transmits data for display of a graph corresponding to the display request to the client terminal 30.

The storage unit 13 is a storage device that stores therein an operating system (OS) executed by the control unit 15 and data used for various programs such as the above-mentioned display program as well.

As an embodiment, the storage unit 13 is mounted as main storage of the server device 10. For example, various semiconductor memory devices, such as a random access memory (RAM), a read-only memory (ROM), and a flash memory, can be employed as the storage unit 13. Furthermore, the storage unit 13 can be mounted as auxiliary storage. In this case, a hard disk drive (HDD), an optical disk, a solid state drive (SSD), etc. can be employed.

The storage unit 13 stores therein, as an example of data used for a program executed by the control unit 15, schedule data 13a and payment data 13b. Besides the schedule data 13a and the payment data 13b, other electronic data, including, for example, identification information such as an address of a client terminal 30, can be stored together.

The schedule data 13a is data on a schedule of events.

As an embodiment, data associated with schedule's items such as start time, end time, length, subject, and category can used as the schedule data 13a. The item “length” here indicates the length of time fixed by the start and end times of an event. Furthermore, the item “category” indicates a category of a load that an event puts on a user. For example, there are the following categories: “off”, “routine work”, “non-routine work”, “important work (customer etc.)”, etc. Out of these, “off” indicates a category to which a private event that is not a public event is assigned. The term “off” here means the time for user's rest and through which the user can be refreshed both physically and mentally; therefore, it can also be recorded as a negative load in a sense. Furthermore, “routine work” indicates a category to which a routinely-performed work in user's duties is assigned. Moreover, “important work (customer etc.)” indicates a category to which a more important work than other works in user's duties is assigned; it can also be recorded as a particularly high load in terms of mental load. Furthermore, “non-routine work” indicates a category to which a work other than the routine work and the important work (customer etc.) in user's duties is assigned. The “non-routine work” is of lower importance than the routine work and the important work (customer etc.) in a sense; therefore, it can also be recorded as a negative load in terms of mental load. Incidentally, items which define the schedule data 13a are not limited to the above-described items cited as examples; other item(s) can be added further, or some of the items can be deleted.

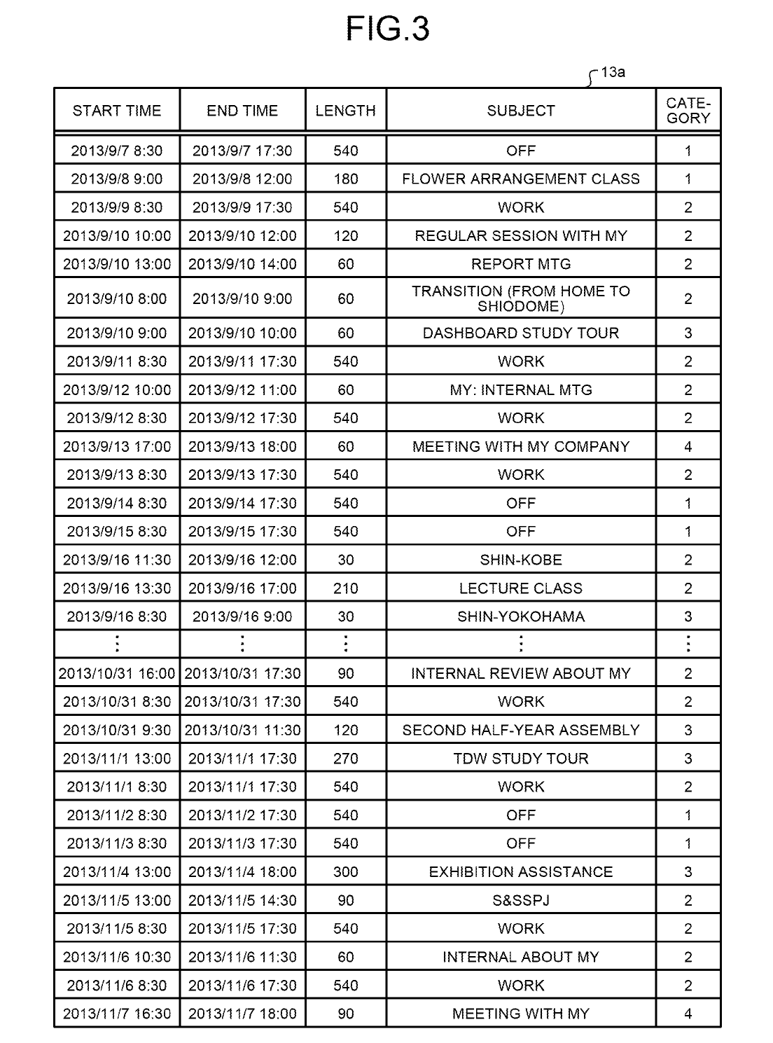

FIG. 3 is a diagram illustrating an example of the schedule data 13a. FIG. 3 depicts an excerpt of given user's schedule for three months from Sep. 7 to Nov. 7, 2013. When a value of category illustrated in FIG. 3 is “1”, it indicates that a category of an event is “off”; “2” indicates that a category of an event is “routine work”; “3” indicates that a category of an event is “non-routine work”; “4” indicates that a category of an event is “important work (customer etc.)”. Incidentally, FIG. 3 depicts given user's records only; however, multiple users' records can be stored in the same data table in such a manner that each record is associated with a corresponding user identifier. In this case, only records associated with an identifier of a user whose graph is to be displayed are extracted and set as processing objects.

For example, to take the first top record in the schedule data 13a illustrated in FIG. 3 as an example, this record indicates that the user took 540 minutes off from work starting from 8:30 to 17:30 on Sep. 7, 2013, and this event falls into the category “off”. The second and subsequent records differ in values of the items from the first record, but are similar to the first record in the sense that a computer can identify an event and identify the duration of a schedule and a category to which the event belongs. Looking at the schedule data 13a illustrated in FIG. 3 as a whole, it indicates out of the records, the first, second, thirteenth, and fourteenth records from the top and the seventh and eighth records from the bottom belong to the category “off”. Furthermore, it indicates the third to sixth, eighth to tenth, twelfth, fifteenth, and sixteenth records from the top and the second to fifth, ninth, twelfth, and thirteenth records from the bottom belong to the category “routine work”. The other categories are no different in that a computer can categorize an event according to an attribute value of category.

The payment data 13b is data on health-related payment.

As an embodiment, data associated with items such as date, classification, subject, and expense can used as the payment data 13b. The item “classification” here indicates classification of a payment object. As an example, the payment object indicates a payee to whom a compensation for a measure aimed at maintenance or restoration of health, i.e., a so-called medical expense is paid; for example, “classification” includes a medical institution to which a user pays a medical fee, a pharmacy to which the user pays a charge for medicine, etc. Furthermore, the item “subject” indicates a subject of the above-mentioned measure; for example, “subject” includes a body region or symptom related to the payment object, etc. Moreover, the item “expense” indicates various medical expenses; for example, “expense” includes a medical fee paid to a medical institution, a charge for medicine paid to a pharmacy, etc. Incidentally, items which define the payment data 13b are not limited to the above-described items cited as examples; other item(s) can be added further, or some of the items can be deleted.

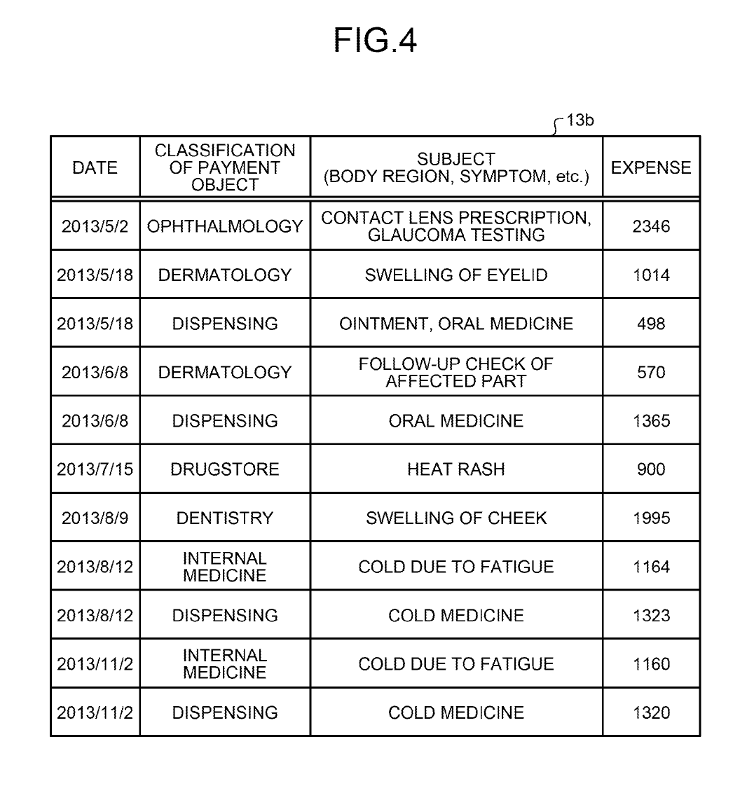

FIG. 4 is a diagram illustrating an example of the payment data 13b. FIG. 4 depicts payment data of the user who has registered the schedule data 13a illustrated in FIG. 3. To take the first top record in the payment data 13b illustrated in FIG. 4 as an example, the user has got a contact lens prescription and received ophthalmic care such as a glaucoma testing at an ophthalmic hospital on May 2, 2013, and its expense was 2346 yen. The second and subsequent records differ in values of the items from the first record, but are similar to the first record in the sense that a computer can identify a payment object, an expense, etc.

The control unit 15 includes an internal memory that stores therein various programs and control data, and executes various processes with these programs and data.

As an embodiment, the control unit 15 is implemented as a central processing unit (CPU). Incidentally, the control unit 15 does not always have to be implemented as a CPU, and can be implemented as a micro processing unit (MPU). Furthermore, the control unit 15 can be realized by a hard-wired logic such as an application specific integrated circuit (ASIC) or a field programmable gate array (FPGA).

The control unit 15 executes various programs, thereby virtually realizing the following processing units. For example, as illustrated in FIG. 2, the control unit 15 includes a first acquiring unit 15a, a second acquiring unit 15b, a receiving unit 15c, an adding-up unit 15d, and a display control unit 15e.

The first acquiring unit 15a is a processing unit that acquires schedule data.

As an embodiment, the first acquiring unit 15a can acquire schedule data of each user through the following channels. For example, the first acquiring unit 15a can acquire schedule data from groupware executed by a server device or the like included in a mission-critical system operated by an organization to which a user belongs. Incidentally, when the server device 10 is implemented as a part of the mission-critical system, the first acquiring unit 15a does not always have to acquire schedule data from an external device, and it only has to use schedule data stored in the storage unit 13 in advance in the healthcare support service. Furthermore, the first acquiring unit 15a can also acquire schedule data from an application program such as a scheduler installed in a client terminal 30.

The second acquiring unit 15b is a processing unit that acquires payment data.

As an embodiment, the second acquiring unit 15b can acquire payment data of each user through the following channels. For example, when a user receives medical care at a medical institution or dispensing at a pharmacy, the medical institution or the like files an insurance claim with a health insurance society of an organization to which the user belongs, i.e., a so-called business operator. In this case, the second acquiring unit 15b can acquire payment data from a server device that manages electronic payment data of a medical fee or medicine charge for which the insurance claim has been filed with the health insurance society. Incidentally, just like the first acquiring unit 15a, when the server device 10 is implemented as a part of the mission-critical system, the second acquiring unit 15b does not always have to acquire payment data from an external device, and it only has to use payment data stored in the storage unit 13 in advance in the healthcare support service. Furthermore, the second acquiring unit 15b can also acquire payment data input to an application program such as a household account book program installed in a client terminal 30.

The data acquisition by the first and second acquiring units 15a and 15b can be executed without a request from a client terminal 30 at intervals of a given period of time or at specified time, or can be executed on demand each time the first and second acquiring units 15a and 15b have received an above-described graph display request from a client terminal 30.

The receiving unit 15c is a processing unit that receives a display request from a client terminal 30.

As an embodiment, the receiving unit 15c can receive an above-described graph display request via a user interface included in a client terminal 30. For example, when the server device 10 is implemented as a part of the mission-critical system, the receiving unit 15c can add a GUI corresponding to a graph display request on a menu screen provided by groupware or the like that the mission-critical system executes. Furthermore, when an application program for client as a front-end of the base that provides the healthcare support service has been installed in a client terminal 30, the receiving unit 15c can receive a graph display request via a GUI provided by the application program. Incidentally, when the application program runs in the background, the receiving unit 15c can receive a graph display request issued by the application program automatically.

Incidentally, here, there is described an example where the server device 10 performs pull-type notification; however, the healthcare support service does not always have to be provided on demand, and the server device 10 can also perform push-type notification. For example, the server device 10 can notify of an above-described graph regularly, or can notify of a graph when the payment data stored in the storage unit 13 has been changed. In this case, the server device 10 does not always have to include the receiving unit 15c.

The adding-up unit 15d is a processing unit that adds up the category-by-category loads from schedule data.

As an embodiment, when the receiving unit 15c has received a graph display request, the adding-up unit 15d retrieves records of the schedule data 13a corresponding to a predetermined span. For example, the adding-up unit 15d retrieves, out of the schedule data 13a stored in the storage unit 13, records of which the date registered as start time of a schedule is included in a span retroactively for a predetermined retroactive period, such as for the past three months, from the time of receipt of a display request from a client terminal 30. After that, the adding-up unit 15d adds up lengths of records having the same category out of the retrieved records on a daily basis. Accordingly, total value of category-by-category lengths is calculated on a daily basis. The total value of lengths calculated by category in this way is one form of loads generated in the day's events corresponding to each category. Incidentally, here, a unit of adding up is on a daily basis; however, the granularity of adding up can be increased to on a weekly or monthly basis, or can be decreased to at intervals of a predetermined time period.

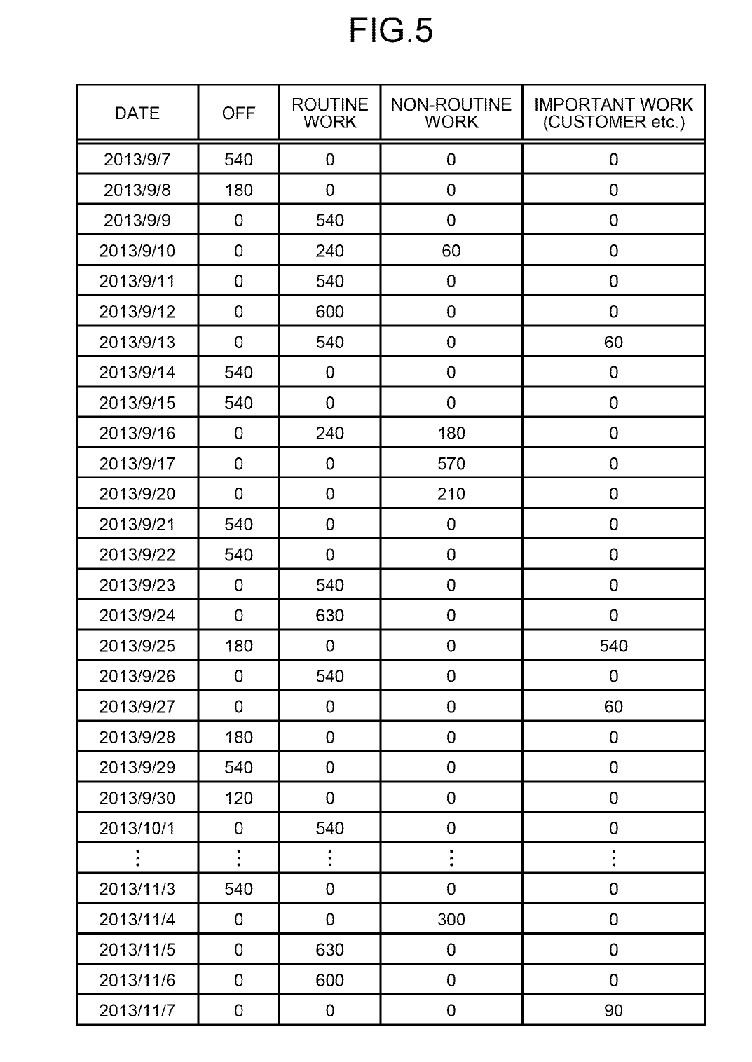

FIG. 5 is a diagram illustrating an example of an adding-up result. FIG. 5 depicts a result of adding up of the schedule data 13a for three months from Sep. 7 to Nov. 7, 2013 illustrated in FIG. 3. For example, when loads on September 10 out of the three months are added up, four records: the fourth to seventh records from the top out of the records in the schedule data 13a illustrated in FIG. 3 are objects to be added up. In this case, there are no records of which the category is “1” or “4”, i.e., “off” or “important work (customer etc.)” in the four records. Therefore, total values of off and important work (customer etc.) on September 10 are both calculated to be “0”. On the other hand, there are three records of which the category is “2” in the four records. That is, the three records of which the category is “routine work” are the fourth, fifth, and sixth records from the top. Therefore, total value of routine work on September 10 is calculated to be “240(=120+60+60) min”. Furthermore, there is one record of which the category is “3” in the four records. That is, the one record of which the category is “non-routine work” is the seventh record from the top. Therefore, total value of non-routine work on September 10 is calculated to be “60 min”. In this way, as to other dates, though an adding-up result is different, category-by-category total value of lengths is calculated by the same logic.

The display control unit 15e is a processing unit that displays a graph indicating time-series load variation and information indicating a payment object or a body region or symptom related to the payment object in a manner temporally associated with the graph on a client terminal 30.

As an embodiment, the display control unit 15e generates a graph indicating category-by-category time-series load variation by sorting category-by-category loads added up on a daily basis by the adding-up unit 15d in the order of date. At this time, the display control unit 15e can generate a graph indicating time-series load variation with respect to each category, or can generate one aggregate graph of respective time-series load variations corresponding to the categories. Specifically, the display control unit 15e piles up category-by-category total values of lengths in predetermined order in a direction corresponding to, out of the coordinate axes of two components of load and time composing a graph, the coordinate axis of load. For example, when category-by-category total values of lengths are piled up in the category order of “off”, “routine work”, “important work (customer etc.)”, and “non-routine work”, a graph composed of multiple layers corresponding to the categories can be generated by painting the category-by-category total values of lengths in different display colors.

In parallel with this, the display control unit 15e retrieves records corresponding to the span out of the payment data 13b stored in the storage unit 13. Then, the display control unit 15e maps a mark indicating either classification of a payment object or a subject included in each record retrieved from the payment data 13b on a position corresponding to date that the record has on the time axis of the graph. Any symbol or graphic can be used as the shape of the mark, and the size of the mark can be arbitrary size. For example, the higher the expense, the larger size of the mark can be formed. In this way, a graph indicating a correlation between time-series variation in physical and mental loads on a user and change in user's physical condition is generated. Incidentally, hereinafter, a mark indicating a payment object or a body region or symptom related to the payment object may be referred to as a “physical condition mark”, and a graph associated with physical condition mark(s) out of graphs may be referred to as a “graph with physical condition mark(s)”.

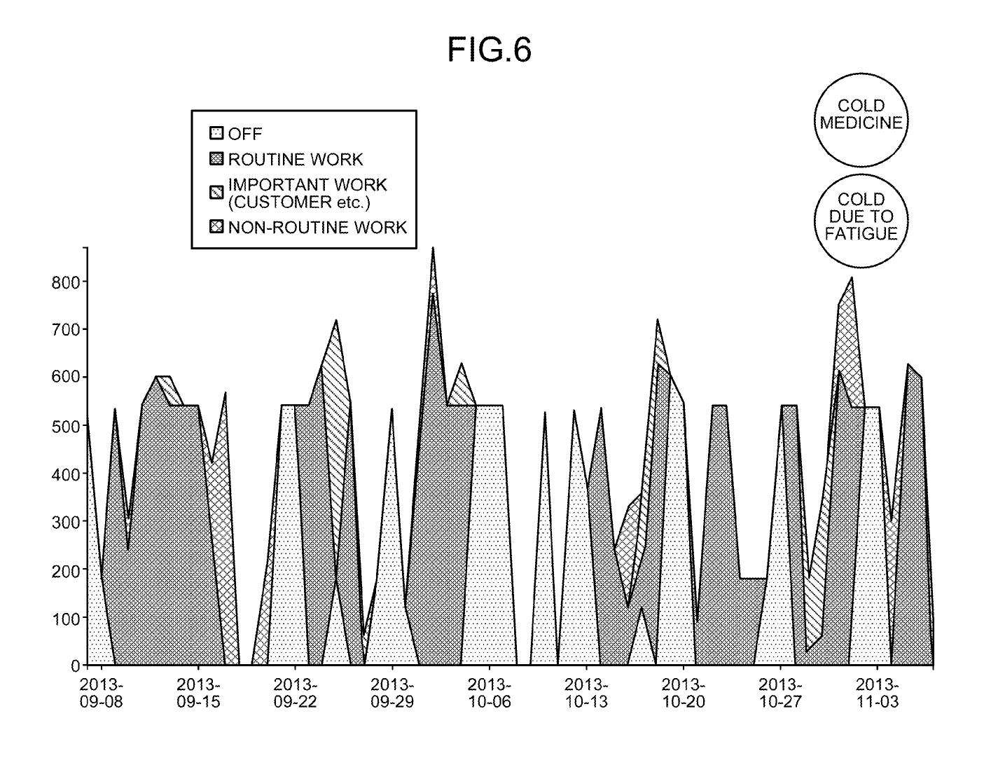

FIG. 6 is a diagram illustrating an example of a graph. FIG. 6 depicts the adding-up result of the schedule data 13a illustrated in FIG. 5 and a graph with physical condition marks generated from the payment data 13b illustrated in FIG. 4. In this example, dates for each week are plotted as the scale of the horizontal axis that is the time axis; however, the scale of the time axis can be set to a shorter interval, such as intervals of a day, or a longer interval, such as intervals of ten days or a month, according to the designation by a user, or can be set according to the length of a display period. Furthermore, FIG. 6 depicts the graph of category-by-category total values of lengths that are piled up in the category order of “off”, “routine work”, “important work (customer etc.)”, and “non-routine work” and painted in different display colors.

In the case of the graph with physical condition marks illustrated in FIG. 6, out of the records included in the payment data 13b illustrated in FIG. 4, the first and second records from the bottom are included in the span of three months from Sep. 7 to Nov. 7, 2013 to be displayed. Therefore, in the graph with physical condition marks illustrated in FIG. 6, together with a graph indicating time-series load variation of “off”, “routine work”, “important work (customer etc.)”, and “non-routine work”, marks relating to medical care and dispensing as physical condition marks are associated with a position corresponding to Nov. 2, 2013 on the time axis of the graph.

The display of the time-series load variation helps a user become aware of loads of “non-routine work”, “routine work”, and “important work (customer etc.)” and a correlation between the length of work hours and a physical load. In addition, the mapping of physical condition marks helps the user grasp his/her tendency of an impact on a mental load arising from the work load. For example, even if works have the same length of work hours, a mental load differs between the categories, i.e., between “non-routine work” which is a work other than the routine work with the exception of the important work with customer and “routine work” or between “routine work” and “important work (customer etc.)” which requests a more polite response than the routine work. For example, it helps a user become aware that the more the “non-routine work”, the fresher the mental condition is getting by freedom from the burden in a sense, or helps a user become aware that the more the “important work (customer etc.)”, the more the mental fatigue is accumulated under the pressure in a sense.

For example, from the graph with physical condition marks illustrated in FIG. 6, it can be seen the fact that a user had engaged in an “important work (customer etc.)” before Nov. 2, 2013 on which the user had a change in physical condition, and after that, the user engaged in a “non-routine work” and then had a schedule of days off. Which work load leads to what kind of mental load differs from one user to another. The output of the graph with physical condition marks helps the user grasp his/her tendency of a correlation between load and change in physical condition that he/she is prone to catch a cold immediately after he/she has been freed from the burden. Accordingly, the user can probe the cause of the change in physical condition, or can take a precaution to avoid catching a cold by tracing the trend of load. Therefore, according to the graph with physical condition marks, it is possible to support individual healthcare effectively.

After that, the display control unit 15e transmits display data of the graph with physical condition marks created in this way to a client terminal 30, thereby displaying the graph with physical condition marks on the client terminal 30.

Flow of Process

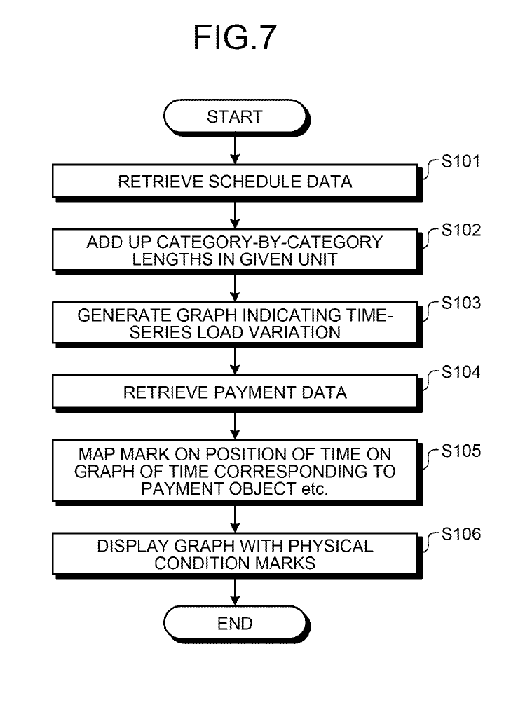

FIG. 7 is a flowchart illustrating a procedure of a display process according to the first embodiment. This display process can be executed without a request from a client terminal 30 at intervals of a given period of time or at specified time, or can be executed each time a request to display the graph has been received from a client terminal 30.

As illustrated in FIG. 7, the adding-up unit 15d retrieves, out of the schedule data 13a stored in the storage unit 13, records of which the date registered as start time of a schedule is included in a span retroactively for a predetermined retroactive period from the date of the execution at Step S101 (Step S101).

Then, the adding-up unit 15d adds up lengths of records having the same category out of the records retrieved at Step S101 in units of a predetermined time width, such as on a daily basis (Step S102). Accordingly, category-by-category lengths are added up as a load on a daily basis.

After that, the display control unit 15e generates a graph indicating category-by-category time-series load variation by sorting category-by-category loads added up on a daily basis at Step S102 in the order of date (Step S103).

Furthermore, the display control unit 15e retrieves records of the payment data 13b stored in the storage unit 13 corresponding to the span for which the records of the schedule data 13a have been retrieved at Step S101 (Step S104).

After that, the display control unit 15e associates a mark indicating either classification of a payment object or a subject included in each record retrieved from the payment data 13b at Step S104 with a position corresponding to date that the record has on the time axis of the graph (Step S105). In this way, a graph indicating a correlation between time-series variation in physical and mental loads on a user and change in user's physical condition is generated.

After that, the display control unit 15e transmits display data of the graph with physical condition marks generated by the mapping of physical condition marks at Step S105 to the client terminal 30, thereby displaying the graph with physical condition marks on the client terminal 30 (Step S106), and the process is terminated.

### Aspect of Effects

As described above, the server device 10 according to the present embodiment displays a graph indicating time-series variation in individual user's load such as work load and information indicating a healthcare payment object or a body region or symptom related to the payment object in a manner temporally associated with the graph. Consequently, the server device 10 according to the present embodiment can visualize a correlation between time-series variation in physical and mental loads on the user and change in user's physical condition. Therefore, the server device 10 according to the present embodiment can support healthcare for individual effectively. Furthermore, the server device 10 according to the present embodiment uses data accumulated naturally just through routine work, such as data on a schedule and health insurance, in generation of an above-mentioned graph with physical condition marks; therefore, it is left out to input any particular information to generate a graph.

### [b] Second Embodiment

The embodiment of the device discussed in the present application is explained above; yet, the present invention can be embodied in various different forms other than the above-described embodiment. Other embodiments included in the present invention are explained below.

Designation of Item on Physical Condition Change

In the above first embodiment, there is described an example where a graph with physical condition marks is generated from schedule data and payment data in a span retroactively for a predetermined retroactive period from the point of time when the execution of the display process has started; the span used in generation of the graph is not limited to this. For example, the server device 10 can determine the span used in generation of the graph by receiving designation of information indicating a payment object or a body region or symptom related to the payment object.

Specifically, when the server device 10 receives a display request from a client terminal 30, a GUI component enabling a user to designate at least any one of doctor's fee, body region, and symptom can be installed on a menu screen through which the client terminal 30 receives the display request. For example, as a GUI component for doctor's fee, a pull-down menu or radio buttons of choices such as ophthalmology, dermatology, internal medicine, and surgery can be installed. Furthermore, as a GUI component for body region, a pull-down menu or radio buttons of choices such as head, chest, and abdomen or choices of the parts at the finer granularity level than the body, such as choices of eye, nose, and mouth, can be installed. Moreover, as a GUI component for symptom, a pull-down menu or radio buttons of choices such as cold and cutaneous inflammation can be installed.

Then, the server device 10 retrieves a record including the same payment object or body region or symptom related to the payment object as a doctor's fee, body region, or symptom of which the designation has been received through the GUI component or a payment object or body region or symptom related to the payment object belonging to a predetermined range of similarity to the doctor's fee, body region, or symptom of which the designation has been received through the GUI component from records of the payment data 13b stored in the storage unit 13. For example, the server device 10 searches for a payment object, body region, or symptom matching the doctor's fee, body region, or symptom of which the designation has been received through the GUI component and a payment object, body region, or symptom whose keyword is associated or synonymous with this. After that, the server device 10 sets a span retroactively for a predetermined retroactive period from the date that the record of the payment data 13b including the payment object, body region, or symptom found as a search result has as a span used in generation of a graph indicating time-series load variation, and can generate a graph with physical condition mark(s). At this time, loads of a few days previous to the very day of the healthcare payment date are likely to be the cause of the change in physical condition, so this period can be set as the retroactive period used in the setting of the span.

Accordingly, the server device 10 can display an amount of work load when the user was in same bad shape in past times as the poor physical condition designated through the client terminal 30. Consequently, it is possible to let the user know what amount of work load is likely to put the user in same bad shape. For example, the server device 10 can receive designation of a medicine for headache or a symptom of headache and generate a graph indicating time-series variation in work load in two weeks before incidence of past headache. By looking at such a graph, the user can realize that what work load put on the user is likely to develop a symptom of headache.

Load Adding-Up Method 1

In the above first embodiment, there is described an example where loads are added up by category; however, it is not always have to add up loads by category. For example, regardless of category, the server device 10 can calculate the total load of each category by adding up lengths of events registered in a schedule corresponding to categories “2” to “4” included in units of a predetermined time width, such as on a daily basis. Furthermore, the server device 10 can narrow down to events registered in a schedule corresponding to at least one or more of categories “2” to “4”, for example, one category of routine work or two categories of routine work and important work (customer etc.) and add up lengths of the events, and set the total value as a load in the time width.

Load Adding-Up Method 2

In the above first embodiment, there is described an example where lengths of records in categories “1” to “4” are all added up as positive values; however, it is not always have to add up lengths of records in all the categories as positive values. For example, out of categories “1” to “4”, lengths of records in categories “1” and “3”, i.e., “off” and “non-routine work” can be added up as negative values. That is, with respect to each date, the server device 10 can add up a daily load by adding, out of lengths of records of the schedule data 13a on the date, lengths of records in categories “2” and “4”, i.e., “routine work” and “important work (customer etc.)” as positive values and subtracting lengths of records in categories “1” and “3”, i.e., “off” and “non-routine work” as negative values. Accordingly, it is possible to evaluate the loads on both positive and negative sides, and as a result, it is possible to calculate a more effective load. Incidentally, here, there is described an example where the total negative value is subtracted from the total positive value; alternatively, a graph indicating time-series load variation can be generated by piling up the category-by-category total negative value in a negative direction of the coordinate axis of load without subtraction of the total negative value.

Load Collecting Method

In the above first embodiment, there is described an example where a load is acquired from schedule data in which events have been registered; however, the load collection source does not always have to be schedule data.

For example, when the clock-in and clock-out times are electronically managed as a time card by groupware or the like executed by a mission-critical system operated by an organization to which a user belongs, time card data can be acquired instead of schedule data. In this case, the server device 10 can calculate the length of work hours with respect to each date by calculating a difference between the clock-in time and the clock-out time. The daily length of work hours can be used as a load. When time card information is used in this way, the date on which the time card is not punched can be considered as an off day, and the duty hours and the off-duty hours can be added up separately. Incidentally, in most organizations, it is often the case that the clock-in and clock-out times are electronically managed in terms of salary and labor. Therefore, the length of work hours does not always have to be calculated from time card data, and the length of work hours can be calculated from salary data or labor data.

Furthermore, the length of work hours can also be calculated from electronically-managed information other than the time card. For example, in most organizations, it is often the case that a user entering and leaving a plant owned by an organization to which the user belongs is managed through an integrated circuit (IC) card in terms of security. Therefore, the server device 10 can calculate the length of work hours with respect to each date by calculating a difference between the entering time and the leaving time by using per-user entering/leaving data associated with the entering and leaving times.

Application of Communication History

In the above first embodiment, there is described an example where the length of work hours is used as a load; however, it is not always have to use the length of work hours as a load. For example, the server device 10 can calculate a communication history as a load. As an example, the server device 10 can use a history of e-mails in calculation of a load. As an example of the e-mail history, the number of sent mails, the number of incoming mails, the number of sent and incoming mails, and data amounts of sent or incoming e-mails or a combination of these can be used.

For example, as a case of using an e-mail history, there is provided an example where the number of sent mails and the number of incoming mails are added up by category, and the total number of each category is used as a load. In this case, the server device 10 targets at sent mails sent on each date included in the span and incoming mails received on the date as objects to be added up, and adds up the number of the sent mails and the number of the incoming mails. In this way, the number of sent mails and the number of incoming mails obtained with respect to each date included in the span are set as category-by-category loads, and a graph with physical condition mark(s) can be generated in the same manner as in the first embodiment. Incidentally, here, there is described an example where the number of sent mails and the number of incoming mails are added up separately; however, it goes without saying that the total number of mails, i.e., the number of sent and incoming mails can be added up in the same manner as the load adding-up method 1.

Here, even when sent mails and incoming mails are the same in number, they do not always be the same in work load. That is, in the case of an incoming mail, a user may just check content of the incoming mail; however, in the case of a sent mail, the user polishes and types an e-mail message and sets an e-mail address while carefully checking these procedures. In this way, a load per mail can be considered to be “(incoming mail)<(sent mail)”.

Accordingly, the server device 10 can calculate an overall category load by normalizing the number of mails in each category between categories of sent mails and incoming mails. For example, the server device 10 sets a weight of an incoming mail to “1” and a weight of a sent mail to “3”, and can use weighted average values of sent mails and incoming mails obtained by taking the weighted average of the sent mails and the weighted average of the incoming mails as an overall category load. At this time, the server device 10 can further add different weight according to an address of a sent mail. For example, it can be said that even if a case of an mail addressed to a co-worker within a company and a case of an mail addressed to a person outside the company are the same in the mail sending procedure, the accuracy expected in the procedure is “(within the company)<(outside the company)”. Therefore, the server device 10 sets a weight of a sent mail addressed to a co-worker within the company to “3” and a weight of a sent mail addressed to a person outside the company to “4”, and can calculate a weighted average value of sent mails and a weighted average value of incoming mails.

Also when an e-mail history is used in calculation of a load in this way, in the same manner as in the first embodiment, it is possible to support healthcare effectively, and also possible to achieve an effect that it is left out to input any particular information to generate a graph.

Incidentally, here, there is described an example where the number of sent mails and the number of incoming mails are added up by category; also when data amounts of sent mails, data amounts of incoming mails, or data amounts of sent and incoming mails are added up, a category-by-category load and an overall category load can be calculated by changing the number of mails to data amounts.

Furthermore, here, there is described an example where an e-mail history is used in calculation of a load; however, the range of application is not limited to an e-mail history. It goes without saying that besides the e-mail history, a call history and a chat history can be used in calculation of a load. For example, in a case of using a call history, the number of outgoing calls, the number of incoming calls, the transmission time, the reception time, and duration of calls or a combination of these are added up as loads with respect to each date included in the span; in a case of using a chat history, the number of sent messages and the number of incoming messages or a combination of these are added up as loads with respect to each date included in the span.

Data Mining

In the above first embodiment, there is described an example where a graph with physical condition marks is displayed on a client terminal 30; alternatively, a result of analysis of the graph with physical condition marks instead of the graph with physical condition marks or together with the graph with physical condition marks can be notified.

For example, the server device 10 can perform various data mining on the graph with physical condition marks. As an example of the data mining, the server device 10 can apply machine learning, such as multiple regression analysis. In this case, as an example, the following learning data derived from the schedule data 13a and the payment data 13b can be used in multiple regression analysis. As an example of the learning data, data in which one objective variable used in multiple regression analysis of each date is associated with multiple explanatory variables can be employed.

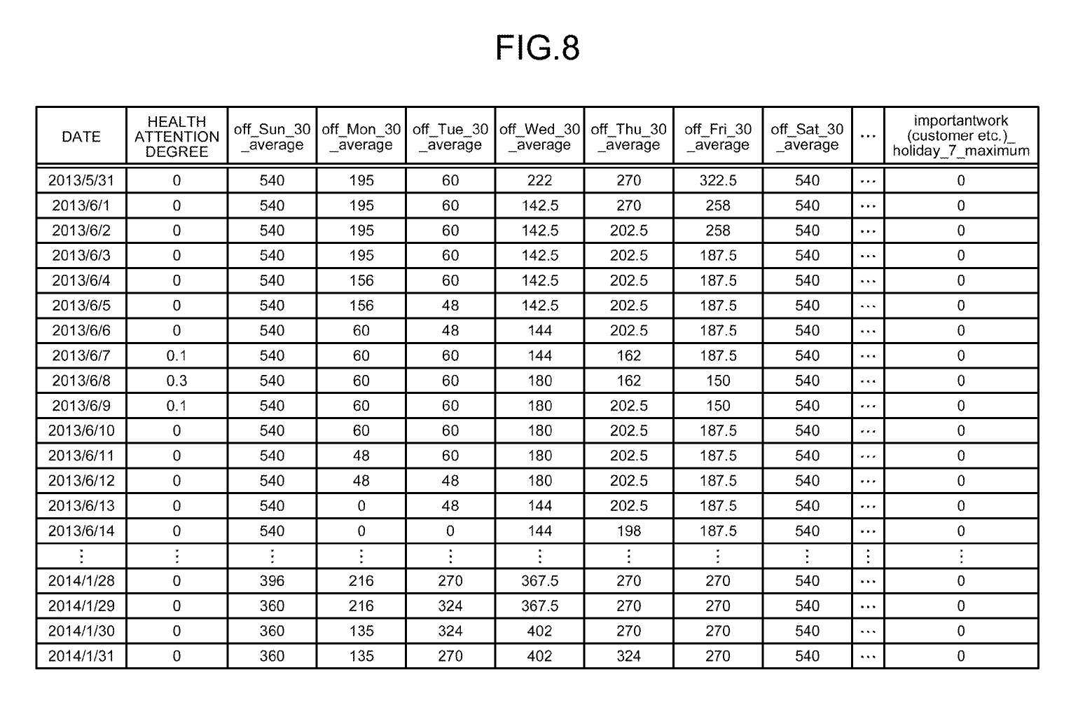

FIG. 8 is a diagram illustrating an example of learning data used in multiple regression analysis. The learning data illustrated in FIG. 8 includes degree of health attention as an example of an objective variable. The degree of health attention indicates a degree that a user has to pay attention to the health. For example, the degree of health attention can quantify an item relating to a change in physical condition, such as a payment object or a body region or symptom related to the payment object, included in the payment data 13b into quantitative data. To cite a concrete example, a weight normalized to a value ranging from 0 to 1 can be added to classification of payment object. For example, it is assumed that a weight of internal medicine is “0.5”, a weight of ophthalmology is “0.4”, a weight of dermatology is “0.3”, and a weight of dentistry is “0.3”. At this time, in the degree of health attention of the same day as the date of a record included in the payment data 13b, a value of a weight corresponding to classification of payment object is directly given as a value of the health attention degree. Furthermore, in the degrees of health attention of dates before or after the very day, a predetermined percentage, for example, one third of the value of the health attention degree on the very day is given.

Moreover, the learning data illustrated in FIG. 8 includes, as an example of explanatory variables, an average and maximum values of “each period” of retroaction from the date, such as last 30 days or last n weeks, an average and maximum values of “each calendar attribute”, such as day of the week, entire day, holiday, and day off, and an average and maximum values in each period of “each category” with respect to each date that each record in the schedule data 13a has. That is, as explanatory variables, off_Sun_{—}30_average, off_Mon_{—}30 average, off_Tue_{—}30_average, off_Wed_{—}30_average, off_Thu_{—}30_average, off_Fri_{—}30_average, off_Sat_{—}30_average, . . . , importantwork(customer etc.)_holiday_{—}7_maximum, etc. are included. Out of these, for example, “off_Sun_{—}30_average” indicates an average value of category “off” on Sundays included in the last 30 days from the date. Furthermore, “importantwork(customer etc.)_holiday_{—}7_maximum” indicates a maximum value of category “important work (customer etc.)” on holidays, i.e., Saturdays, Sundays, and holidays included in the last 7 days from the date.

For example, out of records illustrated in FIG. 8, to take a record on Jun. 8, 2013 as an example, it is indicated that against a backdrop that classification of payment object “dermatology” has been recorded in the fourth top record in the payment data 13b illustrated in FIG. 4, the weight of “0.3” corresponding to dermatology is set in health attention degree. Furthermore, in “off_Sun_{—}30_average”, it is indicated that “540 (min)” is calculated as an average value of category “holiday” on Sundays included in the last 30 days from Jun. 8, 2013. Moreover, in “importantwork(customer etc.)_holiday_{—}7_maximum”, it is indicated that “0 (min)” is calculated as a maximum value of category “important work (customer etc.)” on holidays, i.e., Saturdays, Sundays, and holidays included in the last 7 days from Jun. 8, 2013. The other records differ in values of the items, but are the same in the method of calculating a value of each item.

Here, the server device 10 sets, out of the learning data illustrated in FIG. 8, the health attention degree as a left-hand objective variable and sets the other items as right-hand explanatory variables, thereby generating a system of equations for a number corresponding to the number of records of the learning data. At this time, the same explanatory variable among equations of the system of equations is assigned a common value of coefficient. That is, a coefficient of the explanatory variable “off_Sun_{—}30_average” is common to the equations of the system of equations. Then, the server device 10 calculates parameters including a coefficient of each explanatory variable by performing multiple regression analysis.

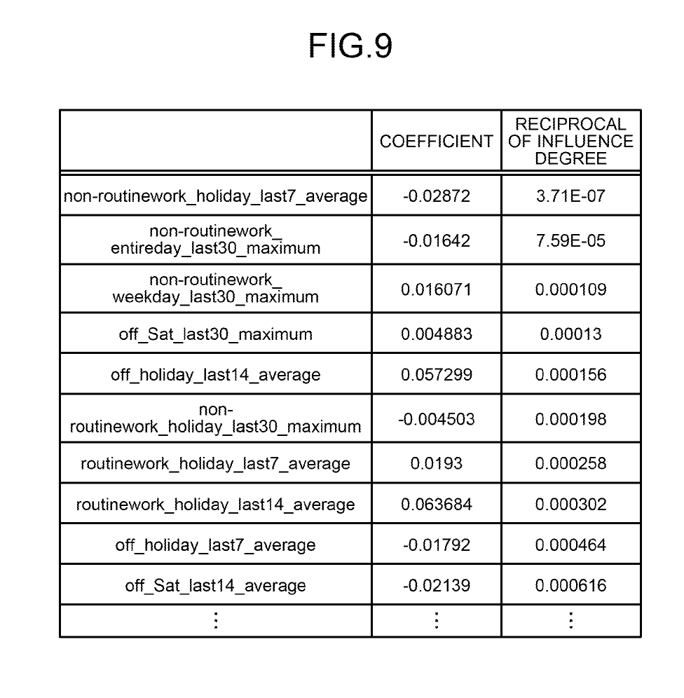

A result of the multiple regression analysis is as illustrated in FIG. 9. FIG. 9 is a diagram illustrating an example of the analysis result. FIG. 9 depicts coefficients of the explanatory variables and reciprocals of influence degree in ascending order of reciprocal, i.e., in descending order of health attention degree. The term “reciprocal of influence degree” here indicates a value obtained by dividing a coefficient of an explanatory variable by a variance of explanatory variables on each date. From the analysis result illustrated in FIG. 9, we can see that in a case of a user having the schedule data 13a illustrated in FIG. 3 and the payment data 13b illustrated in FIG. 4, top three explanatory variables are “non-routinework_holiday_{—}7_average”, “non-routinework_entireday_{—}30_maximum”, and “non-routinework_weekday_{—}30_maximum”, one of factors greatly affecting the degree of health attention is non-routinework.

In this case, the server device 10 can output the following message to a client terminal 30. That is, as an example, a message “Health Advice: For xxx, [non-routinework] is a source of energy. If you feel a bit tired, refresh yourself. And, working on a holiday is a source of stress, so keep within proper bound . . . ” is output.

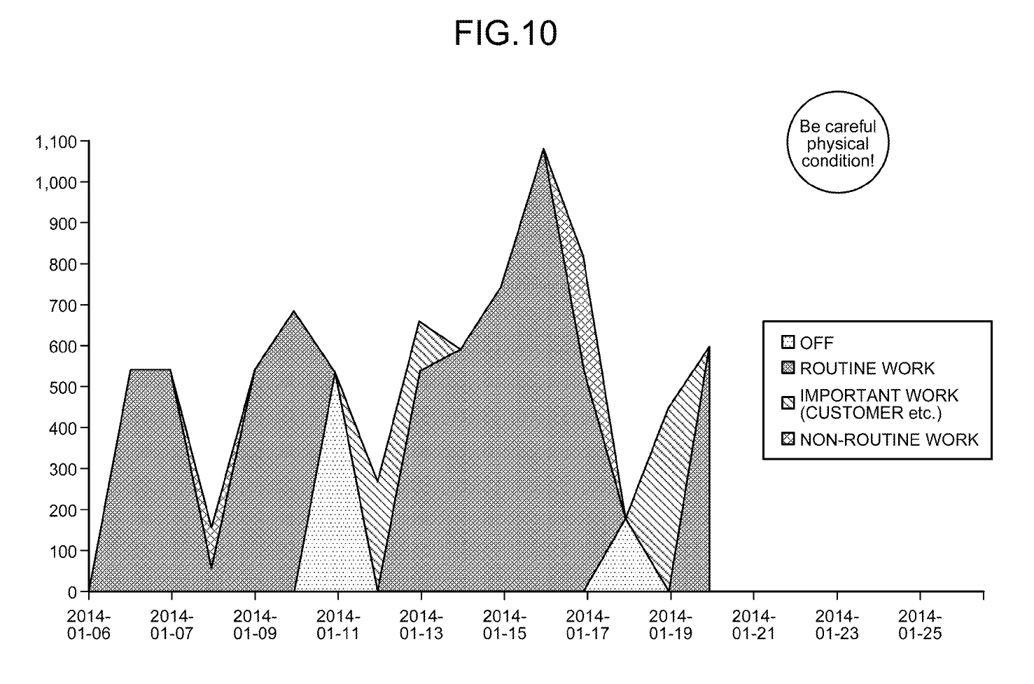

Furthermore, the server device 10 can display a graph illustrated in FIG. 10. FIG. 10 is a diagram illustrating an example of notification of an analysis result. FIG. 10 depicts a mark of an alert for health is plotted on a graph from a result of analysis on Jan. 20, 2014. That is, a degree of health attention is calculated by multiplying the coefficients of the explanatory variables obtained from the analysis result illustrated in FIG. 9 by coefficients of the explanatory variables included in a record on Jan. 20, 2014, and, when the degree of health attention is zero or more, or is equal to or more than a predetermined threshold, for example, 0.3, mark of an alert such as “Be careful physical condition!” can be displayed as illustrated in FIG. 10.

In this manner, by notifying a client terminal 30 of a graph with physical condition mark(s), a user can easily grasp information that is hard to grasp from visual observation only, for example, what category of event is important for user's health or whether the current health condition tends to be good or not.

Incidentally, here, there is described an example where each classification of payment object is quantified in common; alternatively, the multiple regression analysis can be performed with respect to each classification of payment object, and a result of the analysis of each classification can be notified.

Identification of Similar Part of Graph

Furthermore, the server device 10 can identify one or more parts of a graph with physical condition mark(s) matching at a predetermined degree of similarity to a graph part specified by a client terminal 30, and can output information indicating a payment object or a body region or symptom related to the payment object that is associated with a time within a time range after a predetermined time since a time corresponding to the identified graph part.

For example, the server device 10 can identify a graph part similar to the graph part specified by the client terminal 30 by calculating a correlated function as an example of the degree of similarity.

To explain this specifically, the server device 10 receives designation of the graph part from the client terminal 30. For example, the server device 10 can receive designation of a point by a user touching on a graph indicating time-series load variation displayed on the client terminal 30 with a pointing device, or can receive designation of a time point by receiving input of a date or the like. In this case, a predetermined part including the time point of which the designation has received, for example, a predetermined section around the designated time point, i.e., a section retroactively for a predetermined period since the designated time point or a section ahead of a predetermined period since the designated time point can be set as the graph part. Furthermore, the server device 10 can receive the graph part by receiving an operation such as a drag-and-drop operation to designate a range on the graph.

After that, the server device 10 shifts a window having the same time length as the graph part of which the designation has received on the waveform of the graph indicating time-series load variation. Then, each time the server device 10 shifts the window on the graph indicating time-series load variation, the server device 10 calculates a correlated function between the waveform of the graph part of which the designation has received and the waveform of the graph part included in the window. After that, the server device 10 extracts a shift amount resulting in the maximum correlated function or a correlated function equal to or larger than a threshold.

When a correlated function is calculated in this way, the server device 10 can selectively use any one of graphs representing respective time-series load variations of the categories as a graph to be used in calculation of the correlated function, or can use a graph representing time-series variation in an overall category load explained in the load adding-up method 1 in calculation of the correlated function.

Then, the server device 10 displays a mark of a payment object or a body region or symptom related to the payment object that is associated with a time within a time range after a predetermined time since a time corresponding to a similar graph part determined by one or more shift amounts obtained in this way together with the similar graph part on the client terminal 30.

Accordingly, it is possible to display what kinds of bad physical conditions have been generated in the previous graph parts having the similar trend to the trend of load of the graph part of which the designation has received from the client terminal 30. Incidentally, here, there is described an example where a mark of change in physical condition obtained from the payment data 13b is displayed together with the similar graph part; however, only the mark of change in physical condition can be displayed.

Stand-Alone

In the above first embodiment, there is described an example where the healthcare support service is provided by building a client server system; however, it is not always have to build a client server system. For example, it is possible to cause a client terminal 30 to perform various processes including the display process illustrated in FIG. 7 stand alone. In this case, a display program for implementing the various processes including the display process illustrated in FIG. 7 is pre-installed, or is installed via a network or a recording medium. That is, a processing unit that performs the same processing as the adding-up unit 15d and the display control unit 15e is mounted in the client terminal 30. In this case, by further mounting the first acquiring unit 15a and the second acquiring unit 15b in the client terminal 30, the client terminal 30 can acquire schedule data and payment data, or can store the schedule data 13a and the payment data 13b in a storage unit included in the client terminal 30 in advance.

Furthermore, in the above embodiments, there is described an example where a user refers to a relationship between his/her work load and physical condition; however, the present invention is not limited to this. For example, it can be configured to receive designation of a second user by an operation made by a first user and display a graph about the second user. For example, a supervisor can use the present system to grasp subordinates' works and influence on their physical conditions.

Display Program

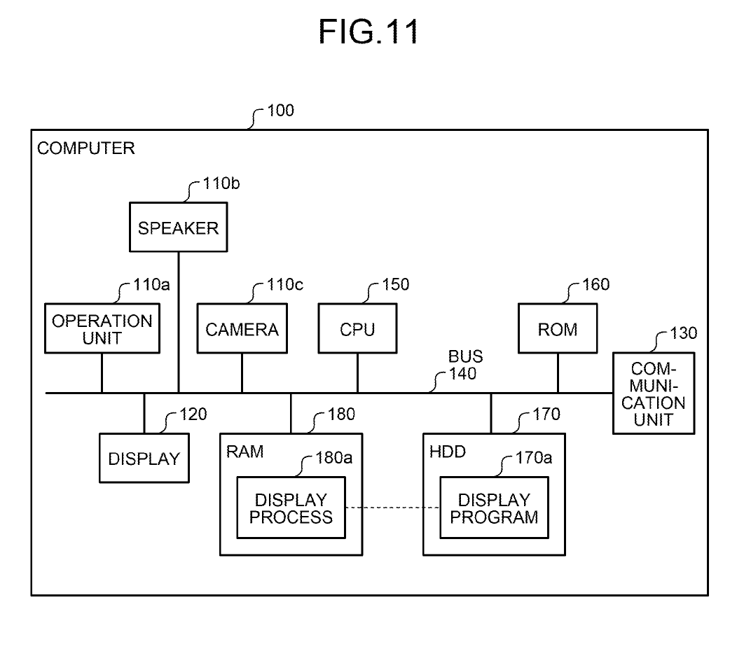

Various processes explained in the above embodiments can be implemented by causing a computer, such as a personal computer or a workstation, to execute a program prepared in advance. An example of a computer that executes a display program having the same functions as in the above embodiments is explained below with FIG. 11.

FIG. 11 is a diagram for explaining an example of a computer that executes the display program according to the first and second embodiments. As illustrated in FIG. 11, a computer 100 includes an operation unit 110a, a speaker 110b, a camera 110c, a display 120, and a communication unit 130. Furthermore, the computer 100 includes a CPU 150, a ROM 160, an HDD 170, and a RAM 180. These units 110 to 180 are connected by a bus 140.

As illustrated in FIG. 11, a display program 170a that fulfills the same functions as the adding-up unit 15d and the display control unit 15e described in the first embodiment has been stored in the HDD 170 in advance. This display program 170a can be appropriately integrated or divided in the same manner as the components of the adding-up unit 15d and the display control unit 15e illustrated in FIG. 2. That is, all data stored in the HDD 170 does not always have to be stored in the HDD 170, and just data used in processes only has to be stored in the HDD 170.

Then, the CPU 150 reads out the display program 170a from the HDD 170, and expands the display program 170a into the RAM 180. Accordingly, the display program 170a serves as a display process 180a as illustrated in FIG. 11. This display process 180a expands various data read out from the HDD 170 into an area allocated to the display process 180a on the RAM 180, and executes various processes based on the expanded data. Incidentally, the display process 180a includes processes performed by the adding-up unit 15d and the display control unit 15e illustrated in FIG. 2, for example, the process illustrated in FIG. 7. Furthermore, all the processing units virtually implemented on the CPU 150 do not always have to run the CPU 150, and just processing units used in processes only have to be virtually implemented.

Incidentally, the display program 170a does not always have to be stored in the HDD 170 or the ROM 160 from the beginning. For example, each program is stored in a “portable physical medium”, such as a flexible disk (FD), a CD-ROM, a DVD, a magneto-optical disk, or an IC card, to be inserted into the computer 100. Then, the computer 100 can read out and execute the program from the portable physical medium. Furthermore, the program can be stored in another computer or a server device connected to the computer 100 via a public line, the Internet, a LAN, a WAN, or the like so that the computer 100 can acquire the program from this and execute the program.

It is possible to support healthcare effectively.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display method comprising:
first displaying, by a processor, a graph indicating time-series variation in load calculated according to a category of an event acquired from schedule information in which events of at least one user have been registered; and
second displaying, by the processor, information indicating a payment object or a body region or symptom related to the payment object extracted from registered payment data of the one user in a manner temporally associated with the graph.

2. The display method according to claim 1, wherein
when designation of information indicating a payment object or a body region or symptom related to the payment object out of the displayed information is received, the second displaying includes extracting a part of the graph corresponding to information indicating the same payment object or body region or symptom related to the payment object as the designated information or a payment object or body region or symptom related to the payment object belonging to a predetermined range of similarity to the designated information from the graph, and includes displaying the extracted part.

3. The display method according to claim 2, wherein
the part of the graph extracted and displayed is a part of the graph in a range retroactively for a predetermined period from a time corresponding to the information indicating the same payment object or body region or symptom related to the payment object as the designated information or a payment object or body region or symptom related to the payment object belonging to the predetermined range of similarity to the designated information.

4. The display method according to claim 1, further including:
identifying one or more parts of a previous graph matching at a predetermined degree of similarity to a designated graph part of the displayed graph, wherein
the second displaying includes outputting information indicating a payment object or a body region or symptom related to the payment object that is associated with a time within the same time range as the identified parts of the graph.

5. The display method according to claim 1, further including:
identifying one or more parts of a previous graph matching at a predetermined degree of similarity to a designated graph part of the displayed graph, wherein
the second displaying includes outputting information indicating a payment object or a body region or symptom related to the payment object that is associated with a time within a time range after a predetermined time since a time corresponding to the identified graph part.

6. The display method according to claim 1, wherein the time-series variation in load is time-series variation in length of work hours.

7. The display method according to claim 1, wherein the time-series variation in load is calculated according to a communication history.

8. The display method according to claim 7, wherein
the communication history is the number of sent mails, the number of incoming mails, the number of sent and incoming mails, and data amounts of sent or incoming e-mails or a combination of these.

9. A non-transitory computer readable recording medium having stored therein a display program that causes a computer to execute a process comprising:
displaying a graph indicating time-series variation in load calculated according to a category of an event acquired from schedule information in which events of at least one user have been registered; and
displaying information indicating a payment object or a body region or symptom related to the payment object extracted from registered payment data of the one user in a manner temporally associated with the graph.

10. A display control device comprising:
a processor that executes a process including;
displaying a graph indicating time-series variation in load calculated according to a category of an event acquired from schedule information in which events of at least one user have been registered, and
displaying information indicating a payment object or a body region or symptom related to the payment object extracted from registered payment data of the one user in a manner temporally associated with the graph.
